(19) United States
(12) Patent Application Publication
(10) Pub. No.: US 2026/0075214 A1
(43) Pub. Date: Mar. 12, 2026

(54) METHOD, APPARATUS AND COMPUTER PROGRAM FOR REDUCING QUALITY DEVIATION BETWEEN IMAGE FRAMES

(71) Applicant: SAMSUNG SDS CO., LTD., Seoul (KR)

(72) Inventors: Youngjin KIM, Seoul (KR); Changbok CHAE, Seoul (KR); Heetae YOON, Seoul (KR); Junho KANG, Seoul (KR)

(73) Assignee: SAMSUNG SDS CO., LTD., Seoul (KR)

(21) Appl. No.: 19/280,308

(22) Filed: Jul. 25, 2025

(30) Foreign Application Priority Data
Sep. 10, 2024 (KR) 10-2024-0123242

(51) Int. Cl. H04N 19/154; H04N 19/136; H04N 19/172; H04N 19/184

(52) U.S. Cl. CPC H04N 19/154; H04N 19/136; H04N 19/172; H04N 19/184

(57) ABSTRACT

The present disclosure relates to a method, an apparatus, and a computer program for reducing a quality deviation between image frames and, more particularly, to a method, an apparatus, and a computer program for reducing a quality deviation between image frames in constant bit rate (CRB) encoding. A method for reducing a quality deviation between image frames, the method comprising: generating a frame-quality measurement value graph by calculating a quality measurement value between an original image frame and an encoded frame; measuring similarity between the frame-quality measurement value graph and a preset problem pattern graph; and changing an encoding setting value when the similarity is a first threshold value or greater.

### CROSS-REFERENCE TO RELATED APPLICATION(S)

This application is based on and claims priority under 35 U.S.C. 119 to Korean Patent Application No. 10-2024-0123242, filed on Sep. 10, 2024, in the Korean Intellectual Property Office, the disclosure of which is herein incorporated by reference in its entirety.

### BACKGROUND OF THE INVENTION

### 1. Field of the Invention

The present disclosure relates to a method, an apparatus, and a computer program for reducing a quality deviation between image frames and, more particularly, to a method, an apparatus, and a computer program for reducing a quality deviation between image frames in constant bit rate (CRB) encoding.

### 2. Description of the Prior Art

Recently, various services that transmit image data through a network have been being provided. For example, a remote video conferencing service transmits and receives video data in real time through a network, thereby providing users with an environment similar to a physical conference.

When transmitting image data via a network, it is advantageous to generate (encode) a certain amount of data by fixing a bit rate so that a bandwidth (BW) may be easily adjusted. Therefore, when transmitting image data through a network, constant bit rate (CBR) encoding is often employed.

In image data encoding, image data obtained from an image source, such as a camera, is encoded to generate an I-frame that serves as a reference and a P-frame that includes differential data from the previous frame. However, constant bit rate encoding needs to maintain a constant amount of encoded data, which may cause quality differences between frames (particularly between an I-frame and a P-frame).

Specifically, in constant bit rate encoding, encoding is performed according to a target bit rate during encoding. Therefore, a large quantity of data needs to be input originally to the I-frame, which serves as a reference frame, but a relatively small amount of data is inevitably allocated to meet the target bit rate, resulting in deterioration in image quality. However, since an amount of data (bit rate) that needs to be allocated originally to the I-frame may be allocated to the P-frame, more image data may be input to the P-frame to gradually improve the image quality of the P-frame, thus causing a great difference from the image quality of the I-frame. In particular, in a video with little movement or a still image, since there is very small or little differential data, more video data is input to the P-frame, which increases the quality difference.

Accordingly, users may feel inconvenience due to the quality difference between image frames in constant bit rate encoding, and solutions thereto are being demanded, but no appropriate solution has been presented yet.

### SUMMARY OF THE INVENTION

The present disclosure has been made in order to solve the above-mentioned problems in the prior art and an aspect of the present disclosure is to provide a method, an apparatus, and a computer program capable of reducing a quality deviation between image frames in constant bit rate encoding.

Another aspect of the present disclosure is to provide a method, an apparatus, and a computer program capable of reducing a quality deviation between an I-frame and a P-frame by changing an encoding setting value in constant bit rate encoding.

Still another aspect of the present disclosure is to provide a method, an apparatus, and a computer program capable of recognizing a decrease in image quality even in constant bit rate encoding by performing quality measurement on an encoded frame.

Yet another aspect of the present disclosure is to provide a method, an apparatus, and a computer program capable of improving the image quality of each frame even in constant bit rate encoding by performing quality measurement on each frame.

Technical aspects to be achieved in the disclosure are not limited to the technical aspects mentioned above, and other technical aspects not mentioned will be clearly understood by those skilled in the art from the following description of the present disclosure.

According to a first embodiment of the present disclosure, a method for reducing a quality deviation between image frames may include: generating a frame-quality measurement value graph by calculating a quality measurement value between an original image frame and an encoded frame; measuring similarity between the frame-quality measurement value graph and a preset problem pattern graph; and changing an encoding setting value when the similarity is a first threshold value or greater.

The quality measurement value may be a peak signal-to-noise ratio (PSNR) or a structural similarity index measure (SSIM).

The frame-quality measurement value graph may be a graph in which a horizontal axis and a vertical axis are a frame number and a quality measurement value, respectively, or a quality measurement value and a frame number, respectively.

The similarity may be cosine similarity.

The first threshold value may be set to a value ranging from 0.8 to 1.0.

The encoding setting value may be at least one of an I-frame size for an I-frame and a quantization parameter (QP) value for a P-frame.

According to a second embodiment of the present disclosure, a method for reducing a quality deviation between image frames may include: generating a frame-quality measurement value graph by calculating a quality measurement value between an original image frame and an encoded frame; measuring similarity between the frame-quality measurement value graph and a preset problem pattern graph; calculating a difference value between a maximum value and a minimum value of the quality measurement value included in the frame-quality measurement value graph when the similarity is a first threshold value or greater; and changing an encoding setting value when the difference value is a second threshold value or greater.

The quality measurement value may be a peak signal-to-noise ratio (PSNR) or a structural similarity index measure (SSIM).

The frame-quality measurement value graph may be a graph in which a horizontal axis and a vertical axis are a frame number and a quality measurement value, respectively, or a quality measurement value and a frame number, respectively.

The similarity may be cosine similarity.

The first threshold value may be set to a value ranging from 0.8 to 1.0.

The second threshold value may be set to a value of 7 or greater when the quality measurement value is a peak signal-to-noise ratio (PSNR), and may be set to a value of 0.05 or greater when the quality measurement value is a structural similarity index measure (SSIM).

The encoding setting value may be at least one of an I-frame size for an I-frame and a quantization parameter (QP) value for a P-frame.

According to a third embodiment of the present disclosure, a method for reducing a quality deviation between image frames in constant bit rate (CRB) encoding may include: transmitting, by an image capture unit, an original image frame to an encoding unit and a quality measurement unit; encoding, by the encoding unit, the original image frame to generate an encoded frame; transmitting, by the encoding unit, the encoded frame to the quality measurement unit; calculating, by the quality measurement unit a quality measurement value between the original image frame and the encoded frame; generating, by the quality measurement unit, a frame-quality measurement value graph by using the calculated quality measurement value; normalizing, by the quality measurement unit, the frame-quality measurement value graph in accordance with the scale of a preset problem pattern graph; transmitting, by the quality measurement unit, the normalized frame-quality measurement value graph to a quality determination unit; measuring, by the quality determination unit, similarity between the normalized frame-quality measurement value graph and the preset problem pattern graph; calculating, by the quality determination unit, a difference value between a maximum value and a minimum value of the quality measurement value included in the frame-quality measurement value graph when the similarity is a first threshold value or greater; changing, by the quality determination unit, an encoding setting value when the difference value is a second threshold value or greater; and transmitting, by the quality determination unit, the changed encoding setting value to the encoding unit.

The quality measurement value may be a peak signal-to-noise ratio (PSNR) or a structural similarity index measure (SSIM).

The frame-quality measurement value graph may be a graph in which a horizontal axis and a vertical axis are a frame number and a quality measurement value, respectively, or a quality measurement value and a frame number, respectively.

The normalizing may include matching an interval between frame numbers of the frame-quality measurement graph to an interval between frame numbers of the preset problem pattern graph and matching an interval between quality measurement values of the frame-quality measurement graph to an interval between quality measurement values of the preset problem pattern graph.

The similarity may be cosine similarity.

The first threshold value may be set to a value ranging from 0.8 to 1.0.

The second threshold value may be set to a value of 7 or greater when the quality measurement value is a peak signal-to-noise ratio (PSNR), and may be set to a value of 0.05 or greater when the quality measurement value is a structural similarity index measure (SSIM).

The encoding setting value may be at least one of an I-frame size for an I-frame and a quantization parameter (QP) value for a P-frame.

The quality measurement unit and the quality determination unit may be configured as a single module, and a function of the quality measurement unit may be performed by the quality determination unit, or a function of the quality determination unit may be performed by the quality measurement unit.

According to a fourth embodiment of the present disclosure, a computer program may be stored in a medium to execute the method for reducing the quality deviation between the image frames in the constant bit rate encoding in combination with hardware.

According to a fifth embodiment of the present disclosure, an apparatus for reducing a quality deviation between image frames may include a processor, wherein the processor may be configured to: generate a frame-quality measurement value graph by calculating a quality measurement value between an original image frame and an encoded frame; measure similarity between the frame-quality measurement value graph and a preset problem pattern graph; calculate a difference value between a maximum value and a minimum value of the quality measurement value included in the frame-quality measurement value graph when the similarity is a first threshold value or greater; and change an encoding setting value when the difference value is a second threshold value or greater.

The quality measurement value may be a peak signal-to-noise ratio (PSNR) or a structural similarity index measure (SSIM).

The frame-quality measurement value graph may be a graph in which a horizontal axis and a vertical axis are a frame number and a quality measurement value, respectively, or a quality measurement value and a frame number, respectively.

The similarity may be cosine similarity.

The first threshold value may be set to a value ranging from 0.8 to 1.0.

The second threshold value may be set to a value of 7 or greater when the quality measurement value is a peak signal-to-noise ratio (PSNR), and may be set to a value of 0.05 or greater when the quality measurement value is a structural similarity index measure (SSIM).

The encoding setting value may be at least one of an I-frame size for an I-frame and a quantization parameter (QP) value for a P-frame.

According to a sixth embodiment of the present disclosure, an apparatus for reducing a quality deviation between image frames in constant bit rate encoding may include a processor, wherein the processor may be configured to enable: an image capture unit to transmit an original image frame to an encoding unit and a quality measurement unit; the encoding unit to encode the original image frame to generate an encoded frame; the encoding unit to transmit the encoded frame to the quality measurement unit; the quality measurement unit to calculate a quality measurement value between the original image frame and the encoded frame; the quality measurement unit to generate a frame-quality measurement value graph by using the calculated quality measurement value; the quality measurement unit to normalize the frame-quality measurement value graph in accordance with the scale of a preset problem pattern graph; the quality measurement unit to transmit the normalized frame-quality measurement value graph to a quality determination unit; the quality determination unit to measure similarity between the normalized frame-quality measurement value graph and the preset problem pattern graph; the quality determination unit to calculate a difference value between a maximum value and a minimum value of the quality measurement value included in the frame-quality measurement value graph when the similarity is a first threshold value or greater; the quality determination unit to change an encoding setting value when the difference value is a second threshold value or greater; and the quality determination unit to transmit the changed encoding setting value to the encoding unit.

The quality measurement value may be a peak signal-to-noise ratio (PSNR) or a structural similarity index measure (SSIM).

The frame-quality measurement value graph may be a graph in which a horizontal axis and a vertical axis are a frame number and a quality measurement value, respectively, or a quality measurement value and a frame number, respectively.

The normalization may be matching an interval between frame numbers of the frame-quality measurement graph to an interval between frame numbers of the preset problem pattern graph and matching an interval between quality measurement values of the frame-quality measurement graph to an interval between quality measurement values of the preset problem pattern graph.

The similarity may be cosine similarity.

The first threshold value may be set to a value ranging from 0.8 to 1.0.

The second threshold value may be set to a value of 7 or greater when the quality measurement value is a peak signal-to-noise ratio (PSNR), and may be set to a value of 0.05 or greater when the quality measurement value is a structural similarity index measure (SSIM).

The encoding setting value may be at least one of an I-frame size for an I-frame and a quantization parameter (QP) value for a P-frame.

The quality measurement unit and the quality determination unit may be configured as a single module, and a function of the quality measurement unit may be performed by the quality determination unit, or a function of the quality determination unit may be performed by the quality measurement unit.

Accordingly, a method, an apparatus, and a computer program for reducing a quality deviation between image frames according to an embodiment of the present disclosure may reduce a quality deviation between image frames in constant bit rate encoding.

Further, a method, an apparatus, and a computer program for reducing a quality deviation between image frames according to an embodiment of the present disclosure may reduce a quality deviation between an I-frame and a P-frame by changing an encoding setting value in constant bit rate encoding.

In addition, a method, an apparatus, and a computer program for reducing a quality deviation between image frames according to an embodiment of the present disclosure may recognize a decrease in image quality even in constant bit rate encoding by performing quality measurement on an encoded frame.

Furthermore, a method, an apparatus, and a computer program for reducing a quality deviation between image frames according to an embodiment of the present disclosure may improve the image quality of each frame even in constant bit rate encoding by performing quality measurement on each frame.

Effects obtainable from the present disclosure are not limited to the effects mentioned above, and other effects not mentioned will be clearly understood by those skilled in the art from the following description of the present disclosure.

### BRIEF DESCRIPTION OF THE DRAWINGS

The accompanying drawings, which are included as a part of the detailed description to help the understanding of the present disclosure, provide embodiments of the present disclosure and describe the technical spirit of the present disclosure in conjunction with the detailed description, in which:

FIG. 1 is a flowchart illustrating a method for reducing a quality deviation between image frames in constant bit rate encoding according to an embodiment of the present disclosure;

FIG. 2 is a flowchart illustrating a method for reducing a quality deviation between image frames in constant bit rate encoding according to an embodiment of the present disclosure;

FIG. 3 is a flowchart illustrating a method for reducing a quality deviation between image frames in constant bit rate encoding according to an embodiment of the present disclosure;

FIG. 4 illustrates the configuration and operation of an apparatus 400 for reducing a quality deviation between image frames in constant bit rate encoding according to an embodiment of the present disclosure;

FIG. 5A and FIG. 5B illustrate a frame-quality measurement value graph showing a great quality deviation between frames according to an embodiment of the present disclosure;

FIG. 6A and FIG. 6B illustrate a frame-quality measurement graph showing an improved quality deviation according to an embodiment of the present disclosure;

FIG. 7 illustrates a preset problem pattern graph according to an embodiment of the present disclosure;

FIG. 8A and FIG. 8B illustrate a screen in which a quality difference occurs between frames according to an embodiment of the present disclosure; and

FIG. 9 illustrates an apparatus 900 to which a proposed method of the present disclosure is applicable.

### DETAILED DESCRIPTION OF THE EXEMPLARY EMBODIMENTS

Hereinafter, embodiments disclosed herein will be described in detail with reference to the accompanying drawings. Aspects, specific advantages, and novel features of the present disclosure will be more apparent from the following detailed description and exemplary embodiments in conjunction with the accompanying drawings.

The concepts of the terms or words used in the specification and claims are appropriately defined by the inventor to describe the disclosure in an optimal manner, and these terms and words should be interpreted as having meanings and concepts in accordance with the technical idea of the present disclosure, are only for describing embodiments, and should not be construed as limiting the present disclosure.

In assigning reference numerals to components, like or similar components are assigned like reference numerals regardless of reference numerals and redundant descriptions thereof will be omitted. As used herein, the terms “module” and “unit” for components are given or interchangeably used only for ease in writing the specification, do not themselves have distinct meanings or functions, and may refer to a software or hardware component.

In describing components of the present disclosure, when a component is expressed in a singular form, it should be understood that the component also includes a plural form unless otherwise specified. Terms “first,” “second,” and the like are used to distinguish one component from another component, but the components are not limited by these terms. It should be understood that when a component is connected or coupled to another component, the component may be connected or coupled to the other element via any other element interposed therebetween.

When a detailed description about related known technology is determined to make the gist of embodiments disclosed herein unclear in describing the embodiments disclosed herein, the detailed description will be omitted herein. In addition, it should be understood that the accompanying drawings are only for easy understanding of the embodiments disclosed herein, and technical ideas disclosed herein are not limited by the accompanying drawings but include all modifications, equivalents, or substitutes included in the spirit and technical scope of the present disclosure.

Hereinafter, illustrative embodiments of a method, an apparatus, and a computer program for reducing a quality deviation between image frames in constant bit rate encoding according to the present disclosure will be described in detail with reference to the attached drawings.

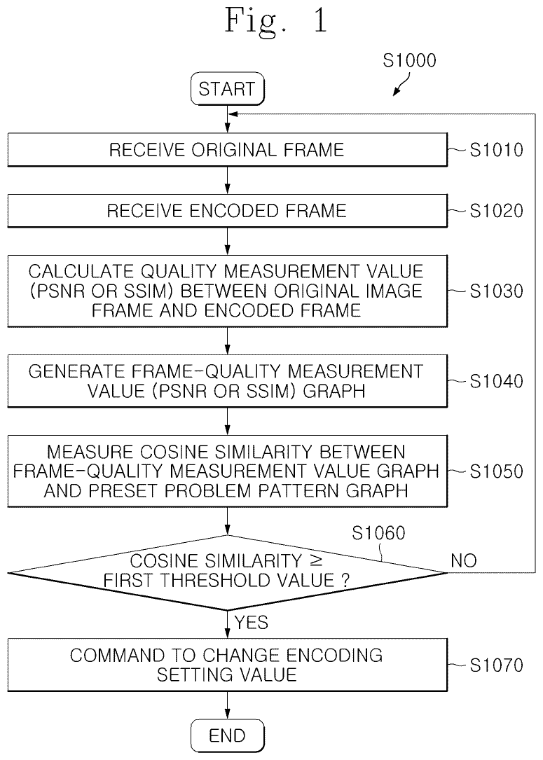

First, FIG. 1 is a flowchart illustrating a method for reducing a quality deviation between image frames in constant bit rate encoding according to an embodiment of the present disclosure.

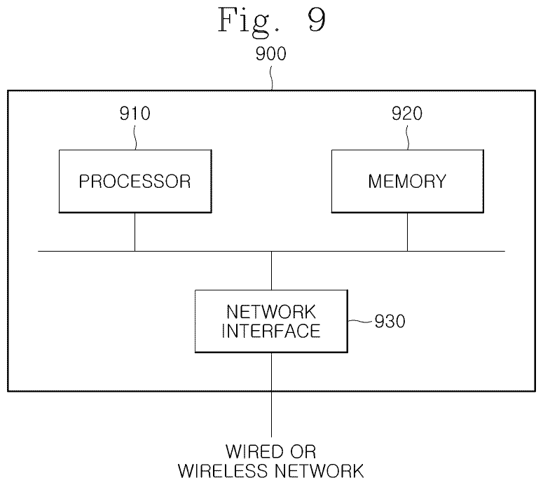

The method illustrated in FIG. 1 may be performed by an apparatus 400 for reducing a quality deviation between image frames or a quality deviation reduction unit 430, and the apparatus 400 for reducing the quality deviation or the quality deviation reduction unit 430 may be configured by including an apparatus 900 described below with reference to FIG. 9. For example, the apparatus 900 of FIG. 9 includes a processor 910, and the processor 910 may execute an instruction configured to reduce a quality deviation between image frames.

Specifically, as illustrated in FIG. 1, the method (S1000) for reducing the quality deviation between the image frames in the constant bit rate encoding according to the embodiment of the present disclosure includes operation S1010 in which the quality deviation reduction unit receives an original image frame from an image capture unit, operation S1020 in which the quality deviation reduction unit receives an encoded frame obtained by encoding the original image frame from an encoding unit, operation S1030 in which the quality deviation reduction unit calculates a quality measurement value between the original image frame and the encoded frame, operation S1040 in which the quality deviation reduction unit generates a frame-quality measurement value graph by using the calculated quality measurement value, operation S1050 in which the quality deviation reduction unit measures similarity between the frame-quality measurement value graph and a preset problem pattern graph, operation S1060 in which the quality deviation reduction unit changes an encoding setting value when the similarity is a first threshold value or greater, and operation S1070 in which the quality deviation reduction unit transmits the changed encoding setting value to the encoding unit.

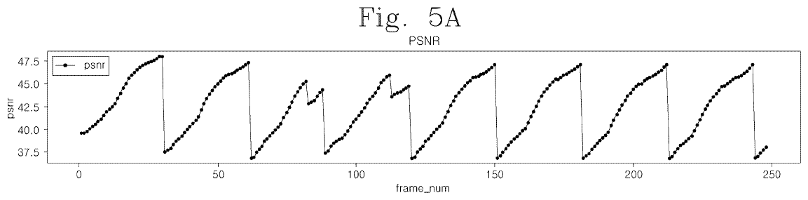

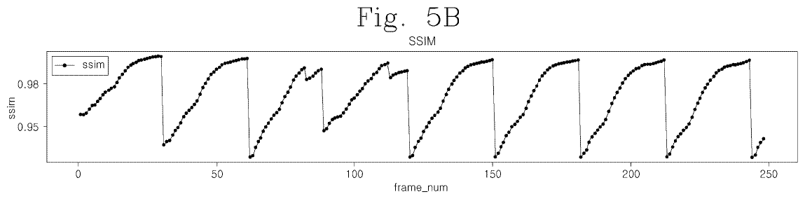

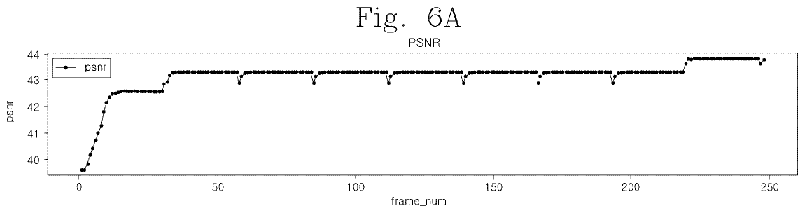

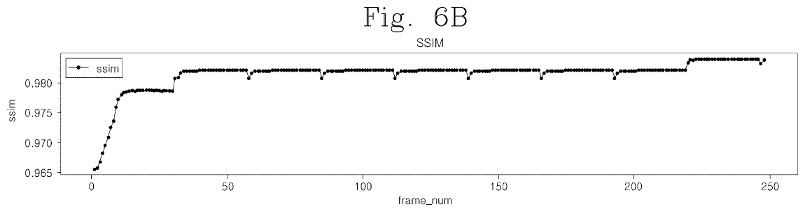

The quality measurement value obtained in operation S1030 may be a peak signal-to-noise ratio (PSNR) or a structural similarity index measure (SSIM), and the frame-quality measurement value graph generated in operation S1040 may be a graph in which a horizontal axis and a vertical axis respectively represent a frame number and a quality measurement value or a graph in which the horizontal axis and the vertical axis respectively represent the quality measurement value and the frame number as illustrated in FIG. 5A, FIG. 5B, FIG. 6A, or FIG. 6B (FIG. 5A, FIG. 5B, FIG. 6A, or FIG. 6B show a graph in which the horizontal axis and the vertical axis respectively represent the frame number and the quality measurement value).

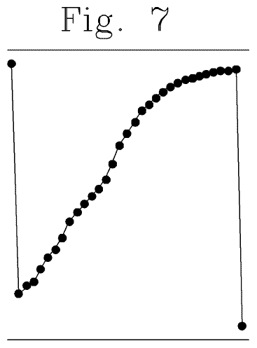

The similarity between the frame-quality measurement graph and the preset problem pattern graph may be cosine similarity. The preset problem pattern graph is a graph showing a great quality measurement value difference between frames as illustrated in FIG. 7, and serves as a criterion for determining whether the generated frame-quality measurement value graph indicates that there is a problem in image quality. That is, when the similarity between the generated frame-quality measurement value graph and the problem pattern graph is high, it is determined that there is a problem in the image quality. The problem pattern graph is stored in advance in a storage medium (not shown), such as a memory, and is provided to the quality deviation reduction unit 430 or a quality determination unit 450 to compare the similarity with the frame-quality measurement value graph.

A target section for comparing the similarity between the frame-quality measurement value graph and the problem pattern graph may be a section formed based on the number of frames between peak and valley points of each graph or the number of frames between one I-frame and the next I-frame.

The cosine similarity is a value for determining the similarity by using the cosine angle between two vectors (since cosine similarity is a widely known conventional technology, a detailed description thereof is omitted). High similarity is denoted by a value close to 1, whereas low similarity is denoted by a value close to −1.

In an embodiment of the present disclosure, the first threshold value for determining that the similarity is high may be set to a value ranging from 0.8 to 1.0.

When the similarity between the generated frame-quality measurement value graph and the problem pattern graph is determined to be high, the encoding setting value is changed to reduce the quality deviation between the image frames. The changed encoding setting value may be at least one of an I-frame size for an I-frame and a quantization parameter (QP) for a P-frame.

Specifically, when a problem pattern is recognized and the quality deviation between the image frames is determined to be great (when the similarity between the generated frame-quality measurement graph and the problem pattern graph is determined to be high), at least one of the I-frame size and a minimum quantization parameter (min QP) for the P-frame is increased. Increasing the I-frame size improves the quality of the I-frame and thus reduces the quality deviation from the P-frame (since bit rate is maintained by a CBR method, the quality of the P-frame may be reduced, and the quality deviation between the I-frame and the P-frame is reduced due to the improved quality of the I-frame and the reduced quality of the P-frame), while increasing the min QP reduces the quality of the P-frame and thus reduces the quality deviation from the I-frame (even though the min QP is increased, the quality of the I-frame hardly changes or insignificantly changes).

In addition to the I-frame size and the min QP, other encoding setting values may also be changed to reduce the quality deviation between the frames.

However, since the I-frame size changes the quality of the I-frame independently from the P-frame and the min QP changes the quality of the P-frame independently from the I-frame, it is desirable to reduce the quality deviation between the frames by changing the I-frame size or the min QP (it is desirable to use an encoding setting value that independently change the quality of the I-frame and the P-frame).

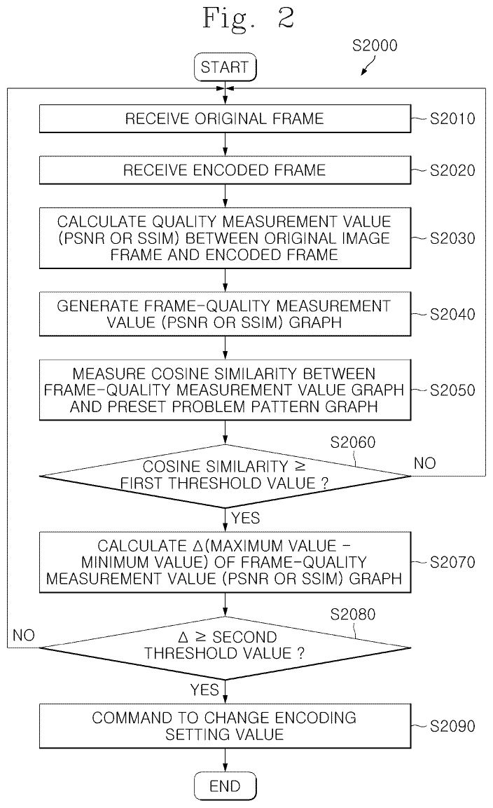

FIG. 2 is a flowchart illustrating a method for reducing a quality deviation between image frames in constant bit rate encoding according to an embodiment of the present disclosure.

The method illustrated in FIG. 2 may be performed by an apparatus 400 for reducing a quality deviation between image frames or a quality deviation reduction unit 430, and the apparatus 400 for reducing the quality deviation or the quality deviation reduction unit 430 may be configured by including an apparatus 900 described below with reference to FIG. 9. For example, the apparatus 900 of FIG. 9 includes a processor 910, and the processor 910 may execute an instruction configured to reduce a quality deviation between image frames.

Specifically, as illustrated in FIG. 2, the method (S2000) for reducing the quality deviation between the image frames in the constant bit rate encoding according to the embodiment of the present disclosure includes operation S2010 in which the quality deviation reduction unit receives an original image frame from an image capture unit, operation S2020 in which the quality deviation reduction unit receives an encoded frame obtained by encoding the original image frame from an encoding unit, operation S2030 in which the quality deviation reduction unit calculates a quality measurement value between the original image frame and the encoded frame, operation S2040 in which the quality deviation reduction unit generates a frame-quality measurement value graph by using the calculated quality measurement value, operation S2050 in which the quality deviation reduction unit measures similarity between the frame-quality measurement value graph and a preset problem pattern graph, operation S2070 in which the quality deviation reduction unit calculates a difference value between a maximum value and a minimum value of the quality measurement value included in the frame-quality measurement value graph when the similarity is a first threshold value or greater (S2060), operation S2080 in which the quality deviation reduction unit changes an encoding setting value when the difference value is a second threshold value or greater, and operation S2090 in which the quality deviation reduction unit transmits the changed encoding setting value to the encoding unit.

The quality measurement value obtained in operation S2030 may be a peak signal-to-noise ratio (PSNR) or a structural similarity index measure (SSIM), and the frame-quality measurement value graph generated in operation S2040 may be a graph in which a horizontal axis and a vertical axis respectively represent a frame number and a quality measurement value or a graph in which the horizontal axis and the vertical axis respectively represent the quality measurement value and the frame number as illustrated in FIG. 5A, FIG. 5B, FIG. 6A, or FIG. 6B (FIG. 5A, FIG. 5B, FIG. 6A, or FIG. 6B show the graph in which the horizontal axis and the vertical axis respectively represent the frame number and the quality measurement value).

The similarity between the frame-quality measurement graph and the preset problem pattern graph may be cosine similarity. The preset problem pattern graph is a graph showing a great quality measurement value difference between frames as illustrated in FIG. 7, and serves as a criterion for determining whether the generated frame-quality measurement value graph indicates that there is a problem in image quality. That is, when the similarity between the generated frame-quality measurement value graph and the problem pattern graph is high, it is determined that there is a problem in the image quality. The problem pattern graph is stored in advance in a storage medium (not shown), such as a memory, and is provided to the quality deviation reduction unit 430 or a quality determination unit 450 to compare the similarity with the frame-quality measurement value graph.

A target section for comparing the similarity between the frame-quality measurement value graph and the problem pattern graph may be a section formed based on the number of frames between peak and valley points of each graph or the number of frames between one I-frame and the next I-frame.

The cosine similarity is a value for determining the similarity by using the cosine angle between two vectors (since cosine similarity is a widely known conventional technology, a detailed description thereof is omitted). High similarity is denoted by a value close to 1, whereas low similarity is denoted by a value close to −1.

In an embodiment of the present disclosure, the first threshold value for determining that the similarity is high may be set to a value ranging from 0.8 to 1.0.

The difference value (Δ) between the maximum value and the minimum value of the quality measurement value calculated in operation S2070 may be calculated from the maximum value and the minimum value of the quality measurement value within a preset number of frames (e.g., the number may vary depending on configurations, such as 20, 30, 50, or 100 frames). In another embodiment, the difference value between the maximum value and the minimum value of the quality measurement value calculated in operation S2070 may be calculated from the maximum value and the minimum value of the quality measurement value within the number of frames between peak and valley points of the frame-quality measurement value graph or the number of frames between one I-frame to the next I-frame.

In an embodiment of the present disclosure, the second threshold value for determining that the difference value is great and thus the quality deviation between the frames is great may be set to a value of 7 or greater when the quality measurement value is the peak signal-to-noise ratio, and may be set to a value of 0.05 or greater when the quality measurement value is the structural similarity index measure.

When the similarity between the generated frame-quality measurement value graph and the problem pattern graph is determined to be high and the difference value between the maximum value and the minimum value of the quality measurement value (PSNR or SSIM) is determined to be great (when the quality deviation between the image frames is determined to be great), the encoding setting value is changed to reduce the quality deviation between the image frames. The changed encoding setting value may be at least one of an I-frame size for an I-frame and a quantization parameter (QP) for a P-frame.

Specifically, when a problem pattern is recognized and the quality deviation between the image frames is determined to be great (when the similarity between the generated frame-quality measurement graph and the problem pattern graph is determined to be high and the difference value between the maximum value and the minimum value of the quality measurement value is determined to be great), at least one of the I-frame size and a minimum quantization parameter (min QP) for the P-frame is increased. Increasing the I-frame size improves the quality of the I-frame and thus reduces the quality deviation from the P-frame (since bit rate is maintained by a CBR method, the quality of the P-frame may be reduced, and the quality deviation between the I-frame and the P-frame is reduced due to the improved quality of the I-frame and the reduced quality of the P-frame), while increasing the min QP reduces the quality of the P-frame and thus reduces the quality deviation from the I-frame (even though the min QP is increased, the quality of the I-frame hardly changes or insignificantly changes).

In addition to the I-frame size and the min QP, other encoding setting values may also be changed to reduce the quality deviation between the frames.

However, since the I-frame size changes the quality of the I-frame independently from the P-frame and the min QP changes the quality of the P-frame independently from the I-frame, it is desirable to reduce the quality deviation between the frames by changing the I-frame size or the min QP (it is desirable to use an encoding setting value that independently change the quality of the I-frame and the P-frame).

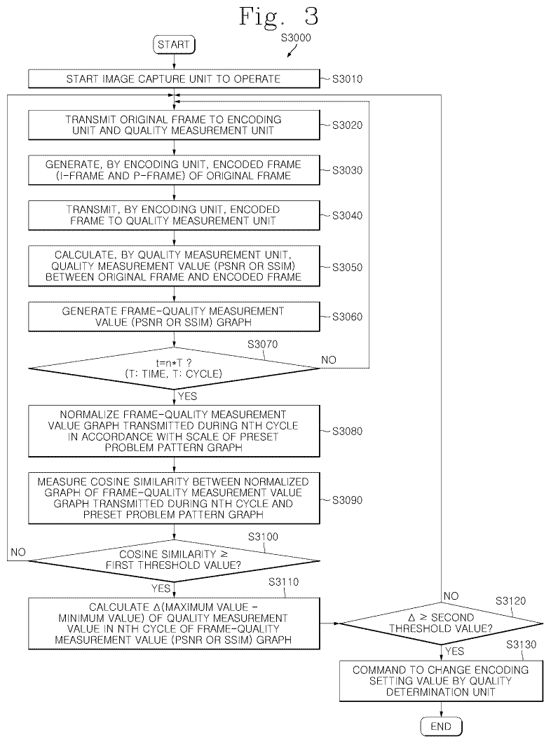

FIG. 3 is a flowchart illustrating a method for reducing a quality deviation between image frames in constant bit rate encoding according to an embodiment of the present disclosure.

The method illustrated in FIG. 3 may be performed by an apparatus 400 for reducing a quality deviation between image frames or a quality deviation reduction unit 430, and the apparatus 400 for reducing the quality deviation or the quality deviation reduction unit 430 may be configured by including an apparatus 900 described below with reference to FIG. 9. For example, the apparatus 900 of FIG. 9 includes a processor 910, and the processor 910 may execute an instruction configured to reduce a quality deviation between image frames.

Specifically, as illustrated in FIG. 3, the method (S3000) for reducing the quality deviation between the image frames in the constant bit rate encoding according to the embodiment of the present disclosure includes operation S3020 in which an image capture unit transmits an original image frame to an encoding unit and a quality measurement unit when the image capture unit starts operating (S3010), operation S3030 in which the encoding unit encodes the original image frame to generate an encoded frame, operation S3040 in which the encoding unit transmits the encoded frame to the quality measurement unit, operation S3050 in which the quality measurement unit calculates a quality measurement value between the original image frame and the encoded frame, operation S3060 in which the quality measurement unit generates a frame-quality measurement value graph by using the calculated quality measurement value, operations S3070 and S3080 in which the quality measurement unit normalizes the frame-quality measurement value graph in accordance with the scale of a preset problem pattern graph, the quality measurement unit transmits the normalized frame-quality measurement value graph to a quality determination unit, operation S3090 in which the quality determination unit measures similarity between the normalized frame-quality measurement value graph and the preset problem pattern graph, operation S3110 in which the quality determination unit calculates a difference value between a maximum value and a minimum value of the quality measurement value included in the frame-quality measurement value graph when the similarity is a first threshold value or greater (S3100), operation S3130 in which the quality determination unit changes an encoding setting value when the difference value is a second threshold value or greater (S3120), and operation S3130 in which the quality determination unit transmits the changed encoding setting value to the encoding unit.

The quality measurement value obtained in operation S3050 may be a peak signal-to-noise ratio (PSNR) or a structural similarity index measure (SSIM), and the frame-quality measurement value graph generated in operation S3060 may be a graph in which a horizontal axis and a vertical axis respectively represent a frame number and a quality measurement value or a graph in which the horizontal axis and the vertical axis respectively represent the quality measurement value and the frame number as illustrated in FIG. 5A, FIG. 5B, FIG. 6A, or FIG. 6B (FIG. 5A, FIG. 5B, FIG. 6A, or FIG. 6B show the graph in which the horizontal axis and the vertical axis respectively represent the frame number and the quality measurement value).

Normalization operations S3070 and S3080 include an operation of matching an interval between frame numbers of the frame-quality measurement graph to an interval between frame numbers of the preset problem pattern graph and matching an interval between quality measurement values of the frame-quality measurement graph to an interval between quality measurement values of the preset problem pattern graph. Normalization of the frame-quality measurement value graph may be performed every predetermined cycle (T). That is, the normalization may be performed at time t (t=n*T where n is the number of cycles) every cycle (T).

The similarity between the frame-quality measurement graph and the preset problem pattern graph may be cosine similarity. The preset problem pattern graph is a graph showing a great quality measurement value difference between frames as illustrated in FIG. 7, and serves as a criterion for determining whether the generated frame-quality measurement value graph indicates that there is a problem in That is, when the similarity between the image quality generated frame-quality measurement value graph and the problem pattern graph is high, it is determined that there is a problem in the image quality. The problem pattern graph is stored in advance in a storage medium (not shown), such as a memory, and is provided to the quality deviation reduction unit 430 or a quality determination unit 450 to compare the similarity with the frame-quality measurement value graph.

A target section for comparing the similarity between the frame-quality measurement value graph and the problem pattern graph may be a section formed based on the number of frames between peak and valley points of each graph or the number of frames between one I-frame and the next I-frame.

The cosine similarity is a value for determining the similarity by using the cosine angle between two vectors (since cosine similarity is a widely known conventional technology, a detailed description thereof is omitted). High similarity is denoted by a value close to 1, whereas low similarity is denoted by a value close to −1.

In an embodiment of the present disclosure, the first threshold value for determining that the similarity is high may be set to a value ranging from 0.8 to 1.0.

The difference value (Δ) between the maximum value and the minimum value of the quality measurement value calculated in operation S3110 may be calculated from the maximum value and the minimum value of the quality measurement value within a preset number of frames (e.g., the number may vary depending on configurations, such as 20, 30, 50, or 100 frames). In another embodiment, the difference value between the maximum value and the minimum value of the quality measurement value calculated in operation S3110 may be calculated from the maximum value and the minimum value of the quality measurement value within the number of frames between peak and valley points of the frame-quality measurement value graph or the number of frames between one I-frame to the next I-frame.

In an embodiment of the present disclosure, the second threshold value for determining that the difference value is great and thus the quality deviation between the frames is great may be set to a value of 7 or greater when the quality measurement value is the peak signal-to-noise ratio, and may be set to a value of 0.05 or greater when the quality measurement value is the structural similarity index measure.

When the similarity between the generated frame-quality measurement value graph and the problem pattern graph is determined to be high and the difference value between the maximum value and the minimum value of the quality measurement value (PSNR or SSIM) is determined to be great (when the quality deviation between the image frames is determined to be great), the encoding setting value is changed to reduce the quality deviation between the image frames. The changed encoding setting value may be at least one of an I-frame size for an I-frame and a quantization parameter (QP) for a P-frame.

Specifically, when a problem pattern is recognized and the quality deviation between the image frames is determined to be great (when the similarity between the generated frame-quality measurement graph and the problem pattern graph is determined to be high and the difference value between the maximum value and the minimum value of the quality measurement value is determined to be great), at least one of the I-frame size and a minimum quantization parameter (min QP) for the P-frame is increased. Increasing the I-frame size improves the quality of the I-frame and thus reduces the quality deviation from the P-frame (since bit rate is maintained by a CBR method, the quality of the P-frame may be reduced, and the quality deviation between the I-frame and the P-frame is reduced due to the improved quality of the I-frame and the reduced quality of the P-frame), while increasing the min QP reduces the quality of the P-frame and thus reduces the quality deviation from the I-frame (even though the min QP is increased, the quality of the I-frame hardly changes or insignificantly changes).

In addition to the I-frame size and the min QP, other encoding setting values may also be changed to reduce the quality deviation between the frames.

However, since the I-frame size changes the quality of the I-frame independently from the P-frame and the min QP changes the quality of the P-frame independently from the I-frame, it is desirable to reduce the quality deviation between the frames by changing the I-frame size or the min QP (it is desirable to use an encoding setting value that independently change the quality of the I-frame and the P-frame).

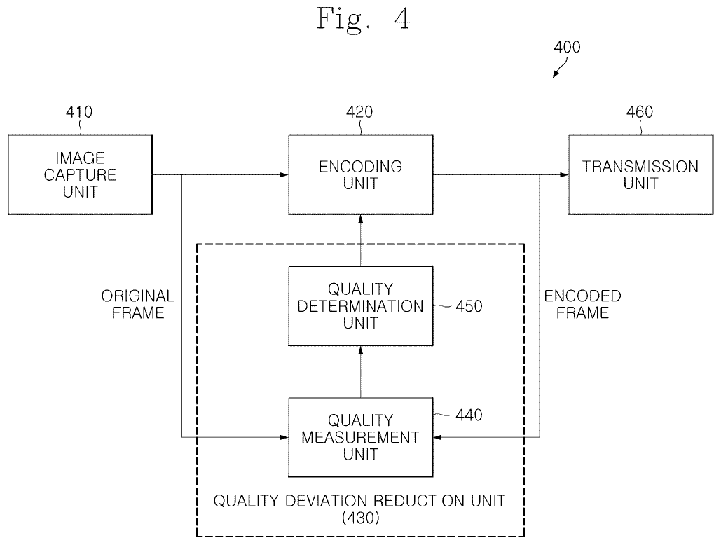

FIG. 4 illustrates the configuration and operation of an apparatus 400 for reducing a quality deviation between image frames in constant bit rate encoding according to an embodiment of the present disclosure. As illustrated in FIG. 4, the apparatus 400 for reducing the quality deviation the between image frames according to the embodiment of the present disclosure includes an image capture unit 410 that captures (photographs) an image, an encoding unit 420 that encodes the captured original image frame, a quality deviation reduction unit 430 that reduces a quality difference between the original image frame and the encoded image frame, and a transmission unit 460 that transmits the encoded frame with a reduced quality deviation to a receiver wirelessly or via a cable. The quality deviation reduction unit 430 may be divided into a quality measurement unit 440 that calculates a quality measurement value between the original image frame and the encoded image frame and a quality determination unit 450 that determines the degree of the quality deviation between the frames.

Hereinafter, the operation of the apparatus 400 for reducing the quality deviation between the image frames according to the embodiment of the present disclosure of FIG. 4 will be described in more detail.

When the image capture unit 410 starts operating through a power-on or shooting start command and performs image capture or shooting, an image frame is collected by the image capture unit 410. The image capture unit 410 transmits the collected original image frame to the encoding unit 420 and the quality measurement unit 440. The encoding unit 420 encodes the received original image frame to generate an encoded frame, and transmits the encoded frame to the quality measurement unit 440. The quality measurement unit 440 calculates a quality measurement value between the original image frame received from the image capture unit 410 and the encoded frame received from the encoding unit 420. The quality measurement unit 440 generates a frame-quality measurement value graph by using the calculated quality measurement value. In some cases, the quality measurement unit 440 normalizes the frame-quality measurement value graph in accordance with the scale of a preset problem pattern graph. The quality measurement unit 440 transmits the normalized frame-quality measurement value graph to the quality determination unit 450. The quality determination unit 450 measures similarity between the normalized frame-quality measurement value graph and the preset problem pattern graph. When the quality determination unit 450 determines that the similarity is the first threshold or greater, the quality determination unit 450 calculates a difference value between a maximum value and a minimum value of the quality measurement value included in the frame-quality measurement value graph. When determining that the difference value is the second threshold or greater, the quality determination unit 450 changes an encoding setting value. The quality determination unit 450 transmits the changed encoding setting value to the encoding unit 420.

The quality measurement value may be a peak signal-to-noise ratio (PSNR) or a structural similarity index measure (SSIM), and the frame-quality measurement value graph may be a graph in which a horizontal axis and a vertical axis respectively represent a frame number and a quality measurement value or a graph in which the horizontal axis and the vertical axis respectively represent the quality measurement value and the frame number as illustrated in FIG. 5A, FIG. 5B, FIG. 6A, or FIG. 6B (FIG. 5A, FIG. 5B, FIG. 6A, or FIG. 6B show the graph in which the horizontal axis and the vertical axis respectively represent the frame number and the quality measurement value).

Normalizing the graph may be matching an interval between frame numbers of the frame-quality measurement graph to an interval between frame numbers of the preset problem pattern graph and matching an interval between quality measurement values of the frame-quality measurement graph to an interval between quality measurement values of the preset problem pattern graph. Normalization of the frame-quality measurement value graph may be performed every predetermined cycle (T). That is, the normalization may be performed at time t (t=n*T where n is the number of cycles) every cycle (T).

The similarity between the frame-quality measurement graph and the preset problem pattern graph may be cosine similarity. The preset problem pattern graph is a graph showing a great quality measurement value difference between frames as illustrated in FIG. 7, and serves as a criterion for determining whether the generated frame-quality measurement value graph indicates that there is a problem in image quality. That is, when the similarity between the generated frame-quality measurement value graph and the problem pattern graph is high, it is determined that there is a problem in the image quality. The problem pattern graph is stored in advance in a storage medium (not shown), such as a memory, and is provided to the quality deviation reduction unit 430 or a quality determination unit 450 to compare the similarity with the frame-quality measurement value graph.

A target section for comparing the similarity between the frame-quality measurement value graph and the problem pattern graph may be a section formed based on the number of frames between peak and valley points of each graph or the number of frames between one I-frame and the next I-frame.

The cosine similarity is a value for determining the similarity by using the cosine angle between two vectors (since cosine similarity is a widely known conventional technology, a detailed description thereof is omitted). High similarity is denoted by a value close to 1, whereas low similarity is denoted by a value close to −1.

In an embodiment of the present disclosure, the first threshold value for determining that the similarity is high may be set to a value ranging from 0.8 to 1.0.

The difference value (Δ) between the maximum value and the minimum value of the quality measurement value may be calculated from the maximum value and the minimum value of the quality measurement value within a preset number of frames (e.g., the number may vary depending on configurations, such as 20, 30, 50, or 100 frames). In another embodiment, the difference value between the maximum value and the minimum value of the quality measurement value may be calculated from the maximum value and the minimum value of the quality measurement value within the number of frames between peak and valley points of the frame-quality measurement value graph or the number of frames between one I-frame to the next I-frame.

In an embodiment of the present disclosure, the second threshold value for determining that the difference value is great and thus the quality deviation between the frames is great may be set to a value of 7 or greater when the quality measurement value is the peak signal-to-noise ratio, and may be set to a value of 0.05 or greater when the quality measurement value is the structural similarity index measure.

When the similarity between the generated frame-quality measurement value graph and the problem pattern graph is determined to be high and the difference value between the maximum value and the minimum value of the quality measurement value (PSNR or SSIM) is determined to be great (when the quality deviation between the image frames is determined to be great), the encoding setting value is changed to reduce the quality deviation between the image frames. The changed encoding setting value may be at least one of an I-frame size for an I-frame and a quantization parameter (QP) for a P-frame.

Specifically, when a problem pattern is recognized and the quality deviation between the image frames is determined to be great (when the similarity between the generated frame-quality measurement graph and the problem pattern graph is determined to be high and the difference value between the maximum value and the minimum value of the quality measurement value is determined to be great), at least one of the I-frame size and a minimum quantization parameter (min QP) for the P-frame is increased. Increasing the I-frame size improves the quality of the I-frame and thus reduces the quality deviation from the P-frame, while increasing the min QP reduces the quality of the P-frame and thus reduces the quality deviation from the I-frame.

In addition to the I-frame size and the min QP, other encoding setting values may also be changed to reduce the quality deviation between the frames.

However, since the I-frame size changes the quality of the I-frame independently from the P-frame and the min QP changes the quality of the P-frame independently from the I-frame, it is desirable to reduce the quality deviation between the frames by changing the I-frame size or the min QP (it is desirable to use an encoding setting value that independently change the quality of the I-frame and the P-frame).

FIG. 5A and FIG. 5B illustrate a frame-quality measurement value graph showing a great quality deviation between frames according to an embodiment of the present disclosure.

Specifically, FIG. 5A illustrates a frame-quality measurement graph in which a quality measurement value is a peak signal-to-noise ratio (PSNR), and FIG. 5B illustrates a frame-quality measurement graph in which a quality measurement value is a structural similarity index measure (SSIM). Although FIG. 5A and FIG. 5B show the frame-quality measurement graphs in which the horizontal axis and the vertical axis respectively are a frame number and the quality measurement value, a graph in which the horizontal axis and the vertical axis respectively are the quality measurement value and the frame number may also be used.

In the graph of FIG. 5A, a difference between a maximum value and a minimum value (peak-valley difference) of the quality measurement value, which is the peak signal-to-noise ratio, is approximately 7 or greater.

In the graph of FIG. 5B, a difference between a maximum value and a minimum value (peak-valley difference) of the quality measurement value, which is the structural similarity index measure is approximately 0.05 or greater.

FIG. 6A and FIG. 6B illustrate a frame-quality measurement graph showing an improved quality deviation according to an embodiment of the present disclosure.

Specifically, FIG. 6A illustrates a frame-quality measurement graph in which a quality measurement value is a peak signal-to-noise ratio (PSNR), and FIG. 6B illustrates a frame-quality measurement graph in which a quality measurement value is a structural similarity index measure (SSIM). Although FIG. 6A and FIG. 6B show the frame-quality measurement graphs in which the horizontal axis and the vertical axis respectively are a frame number and the quality measurement value, a graph in which the horizontal axis and the vertical axis respectively are the quality measurement value and the frame number may also be used.

In the graph of FIG. 6A, a difference between a maximum value and a minimum value (peak-valley difference) of the quality measurement value, which is the peak signal-to-noise ratio, is approximately 1 or less.

In the graph of FIG. 6B, a difference between a maximum value and a minimum value (peak-valley difference) of the quality measurement value, which is the structural similarity index measure is approximately 0.03 or less.

FIG. 7 illustrates a preset problem pattern graph according to an embodiment of the present disclosure.

As illustrated in FIG. 7, the preset problem pattern graph is a graph showing a great quality measurement value difference between frames, and serves as a criterion for determining whether the generated frame-quality measurement value graph indicates that there is a problem in image quality. That is, when the similarity between the generated frame-quality measurement value graph and the problem pattern graph is high, it is determined that there is a problem in the image quality. The problem pattern graph is stored in advance in a storage medium (not shown), such as a memory, and is provided to the quality deviation reduction unit 430 or a quality determination unit 450 to compare the similarity with the frame-quality measurement value graph.

The preset problem pattern graph is formed based on the number of frames in which a difference between a maximum value and a minimum value (peak-valley difference) of a quality measurement value appears or based on the number of frames between one I-frame to the next I-frame.

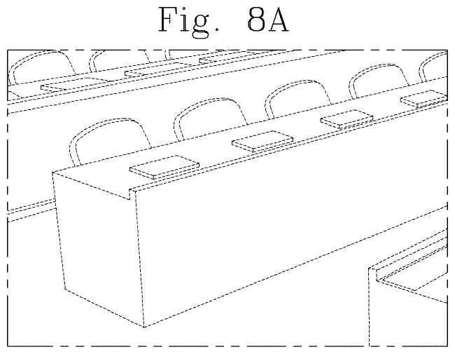

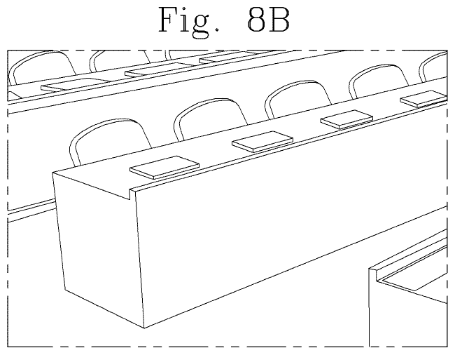

FIG. 8A and FIG. 8B illustrate a screen in which a quality difference occurs between frames according to an embodiment of the present disclosure.

In constant bit rate (CBR) encoding, encoding is performed according to a target bit rate. In this case, since an I-frame serves as a reference frame, a large quantity of data originally needs to be input thereto, but a large quantity of data may not be allocated to meet the target bit rate, resulting in deterioration in image quality (FIG. 8A, low image quality is indicated by a dotted line). The remaining bits are allocated to a P-frame, and in a case of a still image without differential data, more data may be allocated to the P-frame, resulting in a phenomenon that image quality gradually improves (FIG. 8B, high image quality is indicated by a solid line).

Device to which a Proposed Method of the Present Disclosure is Applicable

FIG. 9 illustrates an apparatus 900 to which a proposed method of the present disclosure is applicable. The apparatus 900 may correspond to the apparatus 400 for reducing a quality deviation between image frames, the quality deviation reduction unit 430, the quality measurement unit 440, the quality determination unit 450, or the like.

Referring to FIG. 9, the apparatus 900 may be a server device or a terminal device configured to implement a process for a method for reducing a quality deviation between image frames.

For example, the apparatus 900 to which the proposed method of the present disclosure is applicable may include a network device, such as a repeater, a hub, a bridge, a switch, a router, and a gateway, a computer device, such as a desktop computer and a workstation, a mobile terminal, such as a smartphone, a portable device, such as a laptop computer, a home appliance, such as a digital TV, and transportation, such as a car. In another example, the apparatus 900 to which the present disclosure is applicable may be included as a part of an application-specific integrated circuit (ASIC) configured in the form of a system on chip (SoC).

A memory 920 may be operatively connected to a processor 910, may store programs and/or instructions for processing and control of the processor 910, and may store data and information used in the present disclosure, control information necessary for data and information processing according to the present disclosure, and temporary data generated in data and information processing. The memory 920 may be configured as a storage device, such as a read-only memory (ROM), a random-access memory (RAM), an erasable programmable read-only memory (EPROM), an electrically erasable programmable read-only memory (EEPROM), a flash memory, a static RAM (SRAM), a hard disk drive (HDD), and a solid-state drive (SSD).

The processor 910 may be operatively connected to the memory 920 and a network interface 930, and controls an operation of each module in the apparatus 900. In particular, the processor 910 may perform various control functions for performing the proposed method of the present disclosure. The processor 910 may also be referred to as a controller, a microcontroller, a microprocessor, or a microcomputer. The proposed method of the present disclosure may be implemented by hardware, firmware, software, or a combination thereof. When the present disclosure is implemented using hardware, an application-specific integrated circuit (ASIC), a digital signal processor (DSP), a digital signal processing device (DSPD), a programmable logic device (PLD), or a field programmable gate array (an FPGA) configured to perform the present disclosure may be included in the processor 910. When the proposed method of the present disclosure is implemented using firmware or software, the firmware or software may include instructions related to a module, a procedure, or a function that perform functions or operations necessary to implement the proposed method of the present disclosure, and the instructions may be stored in the memory 920 or stored in a computer-readable recording medium (not shown) separate from the memory 920 and be configured to cause the apparatus 900 to implement the proposed method of the present disclosure when executed by the processor 910.

The apparatus 900 may include a network interface device 930. The network interface device 930 may be operatively connected to the processor 910, and the processor 910 may control the network interface device 930 to transmit or receive a wireless/wired signal carrying information and/or data, a signal, and a message through a wireless/wired network. The network interface device 930 may support various communication standards, for example, IEEE 802 series, 3GPP LTE(-A), and 3GPP 5G, and may transmit and receive control information and/or a data signal according to the communication standards. The network interface device 930 may also be configured outside the apparatus 900 as needed.

The foregoing embodiments and drawings described herein are only for illustration, and are not intended to otherwise limit the scope of the present disclosure in any way. Connections of lines or connecting members between components shown in the drawings are intended to represent illustrative functional connections and/or physical or circuital connections, and may be present as alternative or additional various functional connections, physical connections, or circuital connections in a practical device. Moreover, no component may be essential to apply the present disclosure unless the component is specifically described as “essential” or “critical.”

As used in the specification of the present disclosure (especially in the claims), the term “the” and similar references are to be construed to cover both a singular form and a plural form. Furthermore, recitation of a range herein is merely intended to cover a disclosure employing each separate value falling within the range, and (unless otherwise indicated herein) each separate value is incorporated into the specification as if it were individually recited herein. In addition, operations presented in the methods of the present disclosure are not necessarily intended to be limited to the order of the operations, and the order may be appropriately changed as needed unless a certain operation needs to necessarily come first depending on the nature of each process. All examples or illustrative terms (e.g., “such as”) used herein are intended merely to explain the present disclosure in detail, and the scope of the present disclosure is not limited by the examples or illustrative terms unless limited by the claims. Further, those skilled in the art can understand that various modifications, combinations, and changes may be configured according to design conditions and elements within the scope of the appended claims or their equivalents.

What is claimed is:

1. A method for reducing a quality deviation between image frames, the method comprising:
generating a frame-quality measurement value graph by calculating a quality measurement value between an original image frame and an encoded frame;
measuring similarity between the frame-quality measurement value graph and a preset problem pattern graph; and
changing an encoding setting value when the similarity is a first threshold value or greater.

2. The method of claim 1, wherein the quality measurement value is a peak signal-to-noise ratio (PSNR) or a structural similarity index measure (SSIM).

3. The method of claim 1, wherein the frame-quality measurement value graph is a graph in which a horizontal axis and a vertical axis are a frame number and a quality measurement value, respectively, or a quality measurement value and a frame number, respectively.

4. The method of claim 1, wherein the similarity is cosine similarity.

5. The method of claim 1, wherein the first threshold value is set to a value ranging from 0.8 to 1.0.

6. The method of claim 1, wherein the encoding setting value is at least one of an I-frame size for an I-frame and a quantization parameter (QP) value for a P-frame.

7. A method for reducing a quality deviation between image frames, the method comprising:
generating a frame-quality measurement value graph by calculating a quality measurement value between an original image frame and an encoded frame;
measuring similarity between the frame-quality measurement value graph and a preset problem pattern graph;
calculating a difference value between a maximum value and a minimum value of the quality measurement value included in the frame-quality measurement value graph when the similarity is a first threshold value or greater; and
changing an encoding setting value when the difference value is a second threshold value or greater.

8. The method of claim 7, wherein the quality measurement value is a peak signal-to-noise ratio (PSNR) or a structural similarity index measure (SSIM).

9. The method of claim 7, wherein the frame-quality measurement value graph is a graph in which a horizontal axis and a vertical axis are a frame number and a quality measurement value, respectively, or a quality measurement value and a frame number, respectively.

10. The method of claim 7, wherein the similarity is cosine similarity.

11. The method of claim 7, wherein the first threshold value is set to a value ranging from 0.8 to 1.0.

12. The method of claim 7, wherein the second threshold value is set to a value of 7 or greater when the quality measurement value is a peak signal-to-noise ratio (PSNR), and is set to a value of 0.05 or greater when the quality measurement value is a structural similarity index measure (SSIM).

13. The method of claim 7, wherein the encoding setting value is at least one of an I-frame size for an I-frame and a quantization parameter (QP) value for a P-frame.

14. A computer program stored in a medium to execute the method for reducing the quality deviation between the image frames in constant bit rate encoding of claim 1 in combination with hardware.

15. An apparatus for reducing a quality deviation between image frames, the apparatus comprising a processor,
wherein the processor is configured to:
generate a frame-quality measurement value graph by calculating a quality measurement value between an original image frame and an encoded frame;
measure similarity between the frame-quality measurement value graph and a preset problem pattern graph;
calculate a difference value between a maximum value and a minimum value of the quality measurement value included in the frame-quality measurement value graph when the similarity is a first threshold value or greater; and
change an encoding setting value when the difference value is a second threshold value or greater.

16. The apparatus of claim 15, wherein the quality measurement value is a peak signal-to-noise ratio (PSNR) or a structural similarity index measure (SSIM).

17. The apparatus of claim 15, wherein the similarity is cosine similarity.

18. The apparatus of claim 15, wherein the first threshold value is set to a value ranging from 0.8 to 1.0.

19. The apparatus of claim 15, wherein the second threshold value is set to a value of 7 or greater when the quality measurement value is a peak signal-to-noise ratio (PSNR), and is set to a value of 0.05 or greater when the quality measurement value is a structural similarity index measure (SSIM).

20. The apparatus of claim 15, wherein the encoding setting value is at least one of an I-frame size for an I-frame and a quantization parameter (QP) value for a P-frame.
